(19) United States
(12) Patent Application Publication
(10) Pub. No.: US 2008/0047348 A1
(43) Pub. Date: Feb. 28, 2008

(54) CONVEYOR BELT SURVEILLANCE

(76) Inventor: Barry C. Brown, Main Beach (AU)

Correspondence Address: CONNOLLY BOVE LODGE & HUTZ LLP, 1875 EYE STREET, N.W., SUITE 1100, WASHINGTON, DC, 20036, US

(21) Appl. No.: 11/845,835

(22) Filed: Aug. 28, 2007

(30) Foreign Application Priority Data
Aug. 28, 2006 (AU) 2006-904678

(51) Int. Cl. G01N 29/00; G10K 11/00

(52) U.S. Cl. 73/599; 367/173

(57) ABSTRACT

The condition of the reinforcing (4) of steel conveyor belts (1) is sensed ultrasonically. Transmitters (T) and receivers (R) are located on the belt. The transmitters are energised for a first fraction of a time interval and the receivers are enabled for a second, and later, fraction of the time interval. The time delay between the first and second fractions is related to the anticipated propagation delay between the transmitters and receivers. In addition, a longitudinally extending rip in the belt can be detected by detecting the absence of, or a reduction in, a received signal at one receiver sent by a transversely located transmitter. A method of ultrasonically assessing the quality of a vulcanised splice (8) in such a belt (1) is also disclosed. A transducer (14) able to function as a transmitter or receiver is also disclosed together with a method of mounting it in contact with the underside of the belt.

The present invention relates to steel cord conveyor belts and, in particular, to the surveillance of conveyor belts in order to detect certain defects in relation to longitudinal rips, splices, and the like.

It is known to magnetically detect the condition of steel reinforcing cords within elastomeric conveyor belts (ie those formed from natural rubber or substitutes for natural rubber and which are reinforced by steel cords). Since the steel cords are embedded within the rubber or other elastomer, the steel cords are not visible. The magnetic analysis indicates the presence of rust and/or fractures within the cords and thus provides an indication of when the conveyor belt is likely to fail under longitudinal tension. Such magnetic systems are relatively robust and have found widespread commercial acceptance.

Conveyor belts vary in length and may be up to several kilometres in total belt length when the forward run and return run are considered. The endless conveyor belt is initially compiled on site from a number of rolls of the belt material (typically having a length of 100-300 metres). The length of the individual rolls is determined by the weight and size of a roll so that it is able to be handled conveniently. At the site of the conveyor structure, the elastomeric material covering the steel cords at each end of the roll is partially stripped back, the steel cords are then singled and are overlapped, and additional raw elastomeric material is applied to the cords. The region of the join or splice is then vulcanised in order to complete the fabrication of the splice.

It is customary in the preparation of the exposed cord ends, to leave in place a small portion of the original elastomer which was bonded to the steel cords during the belt manufacture. This provides a good bonding ‘host’ for the incoming raw elastomer, in the splice zone.

The strength of the splice is dependent upon the degree of overlap of the opposing reinforcing cords and also upon the nature of the bond of the vulcanised material since it is this bond which permits the longitudinal tensile forces from one section of the conveyor belt to be transferred to the next section of the conveyor belt.

High resolution radiographs (or X-rays) of splices are able to provide evidence of bond failure within a splice, after such failure has occurred. Magnetic detection techniques and visual observation can confirm the existence of advanced bond failure. In both instances, bond failure must have reached the stage where individual cord movement has physically occurred within the splice. In the case of radiographs, this cord movement can be detected early enough in the splice failure process to allow for replacement of the splice in scheduled downtime. However, the high resolution required for such radiographs necessitates that the belt be stopped during the radiographing process. Further, the belt must be parked very accurately so that splices are located precisely under the radiographic equipment. This entails running the belt at inspection speed, so in a long belt containing say fifty splices or more, very extensive downtime is required.

Detection of advanced splice failure using magnetic or visual techniques can be done with the belt running, but is successful only very late in the splice failure process. Usually this means that the conveyor must be stopped immediately for emergency splice replacement, leading to un-scheduled downtime and the significant attendant consequential economic losses involved.

None of the above techniques measures cord/elastomer bonding directly, and none is effective until splice failure is actually occurring.

Failure of a conveyor belt as a result of longitudinal tensional forces, which often manifests itself in the failure of a splice, is not the only mechanism of failure of such conveyor belts. The conveyor belts are also subject to longitudinally extending rips or tears. These can be either full through rips or partial depth rips. Such rips are often initiated by tramp metal falling onto the belt, particularly at the point of loading of the material to be carried on the belt. In order to reduce the severity of the rip, and thus the length of the rip, it is imperative to halt the operation of the conveyor as soon as possible after such a rip occurs. For this reason longitudinal rip detectors are highly desirable. The total economic loss resulting from a fracture or longitudinal rip in a belt can be very substantial in terms of replacement cost of the belting itself, the cost of cleaning up the dropped material, repairs to damaged structures, the lost production while the transport facility is unavailable, and the market losses arising through failure to be able to supply spot contracts, for example.

Australian Patents Nos. 558,911 and 575,424 disclose a longitudinal rip detector mechanism which uses ultrasonic energisation of the belt. Although such rip detectors have been installed and used commercially, they have not been robust and have not progressed beyond essentially a commercial experimentation stage.

It is the object of the present invention to improve the state of the conveyor belt surveillance arts by the provision of improved apparatus and methods by which the overall operational integrity of steel reinforced elastomeric conveyor belts can be assessed.

In accordance with a first aspect of the present invention there is disclosed a method of ultrasonically sensing the condition of a steel reinforced elastomeric conveyor belt whilst the belt is moving using a first plurality of ultrasonic transmitters and a second plurality of ultrasonic receivers, said method comprising the steps of:

(i) repeatedly energising said transmitters for a first fraction only of a predetermined time interval, and

(ii) enabling said receivers for a second, and later, fraction only of each said predetermined time interval, the time delay between said first and second fractions being related to the anticipated propagation time between said transmitters and receivers.

In accordance with a second aspect of the present invention there is disclosed a method of detecting a longitudinally extending rip in a steel reinforced elastomeric conveyor belt having longitudinally extending steel cords whilst said belt is moving, said method comprising the steps of:

(i) positioning at least one ultrasonic transmitter adjacent one surface of said belt,

(ii) positioning a plurality of ultrasonic receivers adjacent said one surface of said belt,

(iii) arranging said transmitter(s) and receivers in spaced apart relationship extending transversely across said belt and with each said transmitter being located intermediate a corresponding pair of receivers,

(iv) exciting said transmitter(s) to cause an ultrasonic vibration to energise aid conveyor belt,

(v) detecting said ultrasonic vibration by the adjacent pair of corresponding receivers, and

(vi) using the absence or reduction of a detected signal between any transmitter/receiver pair to respectively signify a full through longitudinal rip or a partial depth longitudinal rip in said conveyor belt.

In accordance with a third aspect of the present invention there is disclosed a method of ultrasonically assessing the quality of a vulcanised splice in steel reinforced elastomeric conveyor belts whilst the belt is moving, said method comprising the steps of:

(i) positioning a plurality of ultrasonic transmitters and ultrasonic receivers in spaced apart locations across said splice,

(ii) exciting said transducers to cause an ultrasonic vibration to energise said splice,

(iii) detecting said ultrasonic vibration by said receivers to thereby generate a received ultrasonic output, and

(iv) repeatedly generating said received ultrasonic output and detecting changes in said received ultrasonic output to signify changes in the condition of said splice.

In accordance with a fourth aspect of the present invention there is disclosed a method of mounting a piezoelectric transducer in contact with a surface of a conveyor belt, said method comprising the steps of:

(i) mounting said transducer to one surface of, and adjacent one end of, a resilient strip,

(ii) mounting the other end of said strip to a support which is stationery relative to said belt,

(iii) selecting the length of said strip and the position of said support so that said strip is longer than the spacing between said belt surface and support,

(iv) deflecting said strip in the downstream direction of travel of said conveyor belt surface whereby the other surface of said strip is resiliently urged into contact with said conveyor belt surface.

Preferred embodiments of the present invention will now be described with reference to the drawings in which:

FIG. 1 is a partial schematic transverse cross-sectional view through a steel cord conveyor belt,

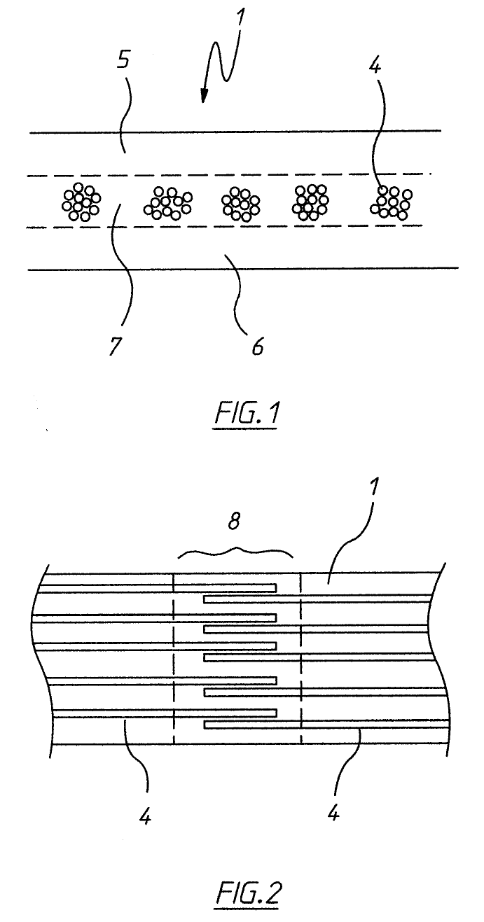

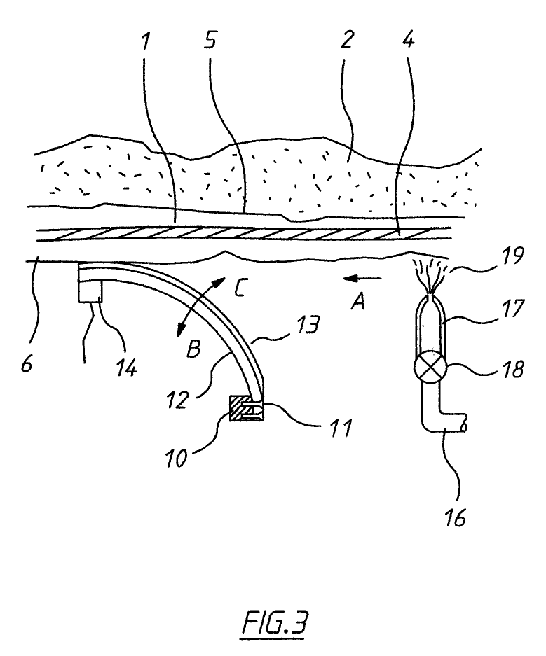

FIG. 2 is a schematic plan view of a common stage 1 or splice in a steel cord conveyor belt,

FIG. 3 is a schematic longitudinal cross-sectional view through a steel cord conveyor belt carrying a load and having an ultrasonic transducer applied to the underside, or pulley cover, of the belt,

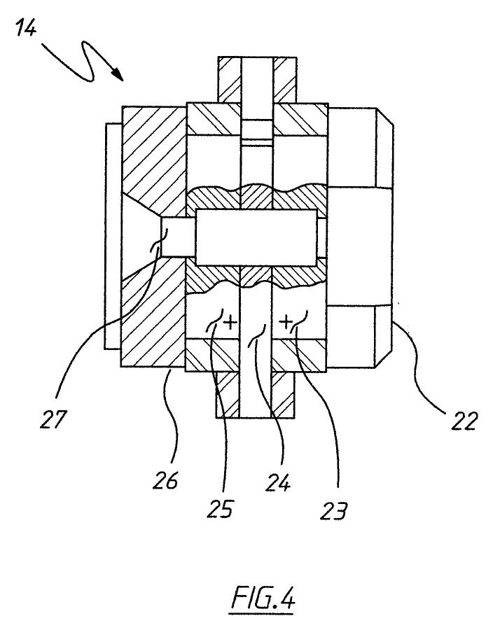

FIG. 4 is a cross-sectional view through the transducer of FIG. 3,

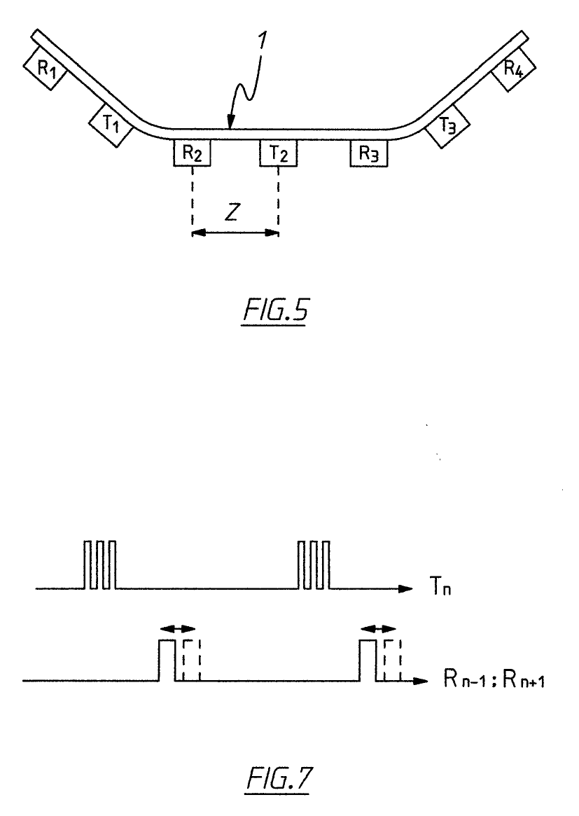

FIG. 5 is a schematic transverse cross-sectional view through an installed conveyor belt showing the position of ultrasonic transmitters and receivers,

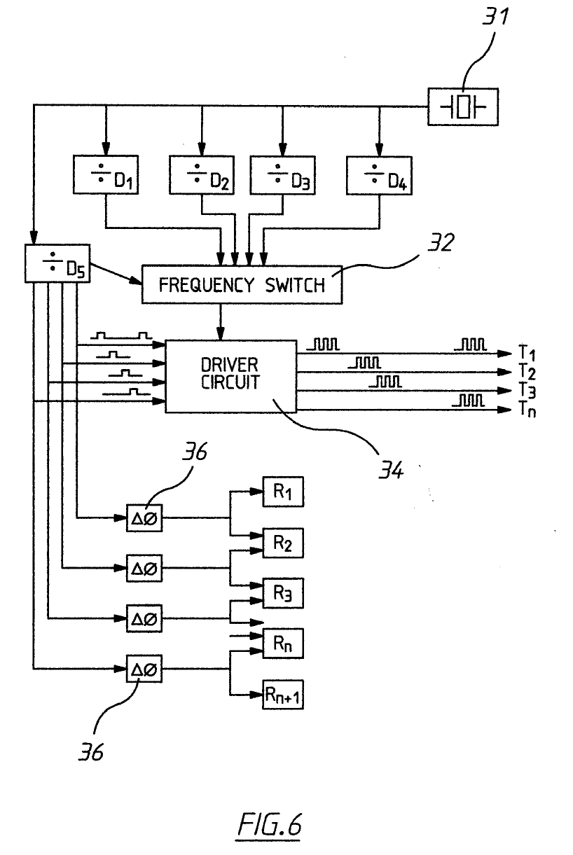

FIG. 6 is a schematic circuit diagram showing the energisation of the transmitters and gating of the receivers, and

FIG. 7 is a timing diagram showing the relationship between the energisation of a given transmitter and the gating of the corresponding adjacent receivers.

As seen in FIG. 1, the conveyor belt 1 is reinforced by longitudinally extending steel cords 4 which lie intermediate an upper carry cover 5 and a lower pulley cover 6. Although the covers 5 and 6 are notionally flat surfaces, in practice they are often severely indented and rough due to wear and tear of the original smooth surface resulting from the initial fabrication of the conveyor belt 1.

Sandwiched between the carry cover 5 and the pulley cover 6 is an intermediate bonder layer 7 which adheres to the cords 4 which are normally galvanised. The carry cover 5 is often specified to be able to meet certain conditions generally arising from the nature of the product load 2 (FIG. 3) to be carried. For example, the carry cover 5 may be required to be oil resistant. However, the pulley cover 6 is rarely specified to have any particular characteristics. Thus the pulley cover 6 could be fabricated from an elastomeric material which is different from that of the carry cover 5.

In general, the provision of any additional fabric members (eg fabric reinforcement or breaker layers) within the belt 1 substantially attenuates its transmission at ultrasonic frequencies. So too do fire retardants and similar chemicals which may be added to the elastomeric formulation. Natural rubber has been found to be a relatively good transmitter of ultrasound acoustic energy, however, many hybrid or synthetic rubber compounds have been found to be very poor transmitters of ultrasonic energy. Typically the elastomeric material selected for splices is a reasonable transmitter of ultrasonic energy. This material in general is selected for ease of vulcanising and its ability to readily bond with the overlapped cords. It will be appreciated that as belts age and are repaired from time to time, the replacement sections of conveyor belt may be of an entirely different compounding from that of the original conveyor belt and thus may, or may not, be as good transmitters of ultrasonic energy as the original belt portions.

Turning now to FIG. 3, the conveyor belt 1 carries the product load 2 and moves in the direction of arrow A. Located underneath the conveyor belt 1 is a frame 10 to which is secured by means of fasteners 11, a strip of spring steel 12, preferably spring stainless steel. The upper surface of the steel strip 12 is coated with a thin layer of ceramic material 13 the thickness of which is exaggerated in FIG. 3 in order to be visible. The ceramic coating 13 merely imparts a hardwearing upper surface to the steel strip 12. Adhered to the underside of the steel strip 12 is a piezoelectric transducer 14, the details of which will be described hereafter in relation to FIG. 4. The steel strip 12 is bent out of its rest position towards the downstream side of the frame 10 and thus is urged by its natural resilience to move in a clockwise direction as indicated by the arrow C in FIG. 3. Since in practice the moving conveyor belt 1 is undulating or flapping, and the pulley cover 6 has many irregularities in its surface, so the pulley cover 6 drives the transducer 14 up and down in a reciprocating motion as indicated by the arrows B and C so that the transducer 14 follows the movement of the lower surface, or pulley cover, 6 of the conveyor belt 1.

Located upstream from the transducer 14 is a water pipe 16 which is connected to a nozzle 17 via a cock 18. Squirting upwardly from the nozzle 17 is a fine spray 19 of water which wets the pulley cover 6 and provides a good ultrasonic coupling medium between the conveyor belt 1 and the transducer 14. The water on he underside of the conveyor belt 1 also renders the lower surface 6 of the conveyor belt to some extent slippery and this ensures good ultrasonic contact between the transducer 14 and the belt 1, and a low level of surface noise generated at the transducer/belt surface interface.

At the heart of the transducer 14 are two piezoelectric annuli 23 and 25 which are separated by a plate 24. These three components 23, 24 and 25 are sandwiched between two apertured plates 22 and 26. A fastener 27 keeps the entire arrangement in compression and thus ensures that notwithstanding vibrational variation in the thickness of the piezoelectric annuli 23 and 25, these annuli remain in compression at all times. The plates 22, 24 and 26 are preferably fabricated from brass. It is the outer surface of the pate 22 which is adhered to the steel strip 12. The arrangement described in FIGS. 3 and 4 has many operational advantages over the transducers disclosed in the abovementioned Australian Patents Nos. 558,911 and 575,424. In particular, the column of water is no longer required.

The abovementioned patents disclose transmission of ultrasonic energy between adjacent transmitters and receivers over a distance of the order of approximately one metre. However, the present inventor has ascertained that such transmission distances are only feasible where good quality natural rubber is the elastomeric material used in the manufacture of the conveyor belt. In general such a good transmission distance is not able to be achieved with belts of different compounding. In order to substantially overcome these difficulties, the transmitters and receivers of the preferred embodiment, which each constitute a transducer 14, are arranged as indicated in FIG. 5. Thus each transmitter T1, T2, T3, etc is positioned intermediate a pair of adjacent receivers R1, R2 (and R2, R3; and R3, R4, etc). In addition, the distance Z between each adjacent receiver and transmitter is shortened to be approximately 200-400 mm depending upon the nature of the ultrasonic properties of the belt.

A consequence of the above described arrangement is that each transmitter only transmits over a relatively short distance via the belt to its adjacent pair of receivers. Thus the magnitude of the signal detected by each receiver is substantially enhanced. Even so, the entire environment of conveyor belt monitoring is essentially a very noisy one and therefore a number of other techniques to be described hereafter are preferably also undertaken.

Turning now to FIG. 6, the method of exciting the transmitters T1, T2, . . . Tn and gating the corresponding receivers R1, R2 . . . Rn+1 will now be described. As seen in FIG. 6, a master clock 31 is provided in the form of a piezoelectric crystal generator the, say, 4 MHz output of which is passed to each of four divider circuits D1-D4. The outputs of the divider circuits create four different excitation frequencies such as 40 kHz, 45 kHz, 50 kHz and 60 kHz which constitute the inputs to an RF switch 32. In addition, the output of the clock 31 is passed through a divider D5 to create a number of sequentially phased “modulation” pulses having a typical pulse repetition rate of approximately 100-200 Hz and a pulse width of approximately 250-600 μS.

The RF switch 32 is indexed by each sequential modulation pulse to select a particular one of the four available excitation frequencies, in sequence. The selected frequency is then delivered to a driver circuit 34 and made available to each transmitter simultaneously. The sequentially phased pulses of the divider D5 are applied to the driver circuit 34 to sequentially enable each driver output in turn. Thus transmitter T1 receives a burst of excitation at a frequency of, say 50 kHz, for a duration of 600 μS and then is turned off. After a short delay, transmitter T2 receives a similar burst of the same frequency for a duration of 600 μS, and so on up to transmitter Tn. Then the cycle is repeated commencing again for transmitter T1 but with the next excitation frequency being delivered from the RF switch 32.

As a consequence, the transmitter T1 is energised at a time which is different from that of the remaining transmitters T2-Tn. In addition, the phased sequential pulses of divider D5 are also applied via a corresponding phase adjusting circuit 36 to gate the receivers pairs R1, R2; R2, R3; . . . Rn, Rn+1. This ensures that just after the time at which transmitter T1 is energised, only receivers R1 and R2 are enabled and all other receivers are disabled. Similarly, just after the time that transmitter T2 is energised, only receivers R2 and R3 are enabled and all other receivers are disabled, etc. This technique ensures that each pair of receivers is only enabled at times when it is expected that the receivers will receive a signal transmitted from their corresponding transmitter. As a consequence, much spurious noise and crosstalk which would otherwise be received by the receivers is eliminated.

Furthermore, as indicated in FIG. 7, the phase adjusting circuits 36 make it possible for the gating pulses applied to each of the receivers to be adjustable in their commencement time. This is desirable because various modes of ultrasonic transmission are possible. The preferred mode is Lamb propagation via the actual belt itself (both symmetrical and asymmetrical Lamb wave propagation is thought possible). As a consequence, the time delay between the commencement of the energisation of the transmitter and the commencement of the gating pulse supplied to the corresponding receivers should be determined by the velocity of sound through the material of the belt itself. In this way, spurious sound propagation paths, such as via any supporting frame, or through the air immediately adjacent the surface of the belt, can be avoided. Clearly, such spurious paths may continue to conduct ultrasound energy in the event of a rip and thus an incorrect result may be the unintended consequence if the spurious transmissions are detected.

The selected excitation frequency within the general range of approximately 40 kHz-approximately 60 kHz is chosen to provide for each particular belt depending upon the nature of the rubber compounds, and other properties of the belt, which change its ultrasonic transmission properties. In addition, the ambient temperature can change these ultrasonic transmission properties so different frequencies can be required in different seasons or different weather conditions. The possible choice of four different excitation frequencies, in quick succession, allows the device to operate successfully on a conveyor belt which contains inserts of differing elastomeric compounding, and over a wide range of ambient temperatures.

In relation to monitoring for longitudinal rips, the techniques described above in relation to FIGS. 5-7 ensure that the reception of ultrasonic energy transmitted via the belt between an adjacent transmitter and receiver can be reliably interpreted as meaning that the belt in the region corresponding to the spacing between these two transducers is intact. It follows that where no such reception is received, as anticipated, then this indicates a defect in the belt itself which is almost certainly a longitudinal rip. Accordingly, such a failure to detect an expected reception is used to actuate an alarm and stop the belt. Similarly, a reduction in reception indicates a partial depth rip.

The inventor has observed that those conveyor belts not having steel reinforcing are extremely poor transmitters of ultrasonic energy and thus although the steel reinforcement constitutes a relatively small percentage of the volume of the conveyor belt, it is clearly critical in the ultrasonic transmission processes. Furthermore, in relation to a splice 8 such as that illustrated in FIG. 2, if the magnitude of received signals transmitted transversely through the belt is initially inadequate, this signifies that the splice has been improperly initially formed and should be re-formed. Similarly, if the received signals diminish over a period of time as the belt is used, this signifies a reduction in the adhesion between the elastomer and the steel cords 4. Thus this can be used to predict the impending failure of a particular splice 8 through loss of adhesion between the overlapped cords 4 and the intervening elastomer material or through “tunnelling”. As a consequence, changes in ultrasonic transmission can be used to identify those splices which are likely to fail and should be x-rayed to verify the diagnosis. The result is that the splice can be replaced prior to failure with a consequent substantial economic saving.

The foregoing describes only some embodiments of the present invention and modifications, obvious to those skilled in the art, can be made thereto without departing from the scope of the present invention.

The term “comprising” (and its grammatical variations) as used herein is used in the inclusive sense of “having” or “including” and not in the exclusive sense of “consisting only of”.

1. A method of ultrasonically sensing the condition of a steel reinforced elastomeric conveyor belt whilst the belt is moving using a first plurality of ultrasonic transmitters and a second plurality of ultrasonic receivers, said method comprising the steps of:
(i) repeatedly energising said transmitters for a first fraction only of a predetermined time interval, and
(ii) enabling said receivers for a second, and later, fraction only of each said predetermined time interval, the time delay between said first and second fractions being related to the anticipated propagation time between said transmitters and receivers.

2. The method as claimed in claim 1 further comprising the steps of:
(iii) at predetermined times, energising said transmitters with a different ultrasonic frequency, and
(iv) at corresponding times, filtering the received signals of said receivers at said transmitted ultrasonic frequency.

3. The method as claimed in claim 2 including the further steps of:
(v) arranging said transmitters and receivers in spaced apart relationship over said belt and with each said transmitter being located intermediate a corresponding pair of receivers, and
(vi) enabling in sequence only one pair of receivers and the corresponding transmitter.

4. The method as claimed in claim 1 wherein said receivers are enabled at a time delayed from the time of initial energisation of said transmitter(s), and said time delay substantially corresponds to the time for an ultrasonic vibration to travel via said belt from a transmitter to a receiver.

5. The method as claimed in claim 4 including the further steps of:
(iii) arranging said transmitters and receivers in spaced apart relationship over said belt and with each said transmitter being located intermediate a corresponding pair of receivers, and
(iv) adjusting said time delay to be the time of travel from each said transmitter to an adjacent one of said receivers.

6. The method as claimed in claim 1 including the further step of:
(iii) arranging said transmitters and receivers in spaced apart relationship over said belt and with each said transmitter being located intermediate a corresponding pair of receivers.

7. A method of detecting a longitudinally extending rip in a steel reinforced elastomeric conveyor belt having longitudinally extending steel cords whilst said belt is moving, said method comprising the steps of:
(i) positioning at least one ultrasonic transmitter adjacent one surface of said belt,
(ii) positioning a plurality of ultrasonic receivers adjacent said one surface of said belt,
(iii) arranging said transmitter(s) and receivers in spaced apart relationship extending transversely across said belt and with each said transmitter being located intermediate a corresponding pair of receivers,
(iv) exciting said transmitter(s) to cause an ultrasonic vibration to energise said conveyor belt,
(v) detecting said ultrasonic vibration by the adjacent pair of corresponding receivers, and
(vi) using the absence or reduction of a detected signal between any transmitter/receiver pair to respectively signify a full through longitudinal rip or a partial depth longitudinal rip in said conveyor belt.

8. A method of ultrasonically assessing the quality of a vulcanised splice in steel reinforced elastomeric conveyor belts whilst the belt is moving, said method comprising the steps of:
(i) positioning a plurality of ultrasonic transmitters and ultrasonic receivers in spaced apart locations across said splice,
(ii) exciting said transducers to cause an ultrasonic vibration to energise said splice,
(iii) detecting said ultrasonic vibration by said receivers to thereby generate a received ultrasonic output, and
(iv) repeatedly generating said received ultrasonic output and detecting changes in said received ultrasonic output to signify changes in the condition of said splice.

9. A method of mounting a piezoelectric transducer in contact with a surface of a conveyor belt, said method comprising the steps of:
(i) mounting said transducer to one surface of, and adjacent one end of, a resilient strip,
(ii) mounting the other end of said strip to a support which is stationery relative to said belt,
(iii) selecting the length of said strip and the position of said support so that said strip is longer than the spacing between said belt surface and support,
(iv) deflecting said strip in the downstream direction of travel of said conveyor belt surface whereby the other surface of said strip is resiliently urged into contact with said conveyor belt surface.

10. The method as claimed in claim 9 comprising the further step of:
(v) fabricating said resilient strip from spring steel.

11. The method as claimed in claim 10 comprising the further step of:
(vi) coating said other surface of said resilient strip with a ceramic wearing layer.

12. The method as claimed in claim 9 including the further step of:
(vii) wetting said conveyor belt surface upstream of said resilient strip.

13. The method as claimed in claim 12 including the further step of:
(viii) spraying said conveyor belt surface with a water mist.
